(19) United States
(12) Patent Application Publication
(10) Pub. No.: US 2020/0300308 A1
(43) Pub. Date: Sep. 24, 2020

(54) HIGH ANGLE UNDERCUT FREE JOINT ASSEMBLY

(71) Applicant: Steering Solutions IP Holding Corporation, Saginaw, MI (US)

(72) Inventor: Jun J. Lu, Saginaw, MI (US)

(21) Appl. No.: 16/359,655

(22) Filed: Mar. 20, 2019

(51) Int. Cl. F16D 3/2237

(52) U.S. Cl. CPC F16D 3/2237

(57) ABSTRACT

An undercut free (UF) joint assembly for a vehicle driveline system is provided and includes an axle bar, an inner race, a stem, an outer race, and a cage. Also included are a plurality of balls retained within the cage, the axle bar able to articulate relative to the outer race, an opening chamfer of the outer race parallel to an outer surface of the axle bar oriented at the required joint angle.

### BACKGROUND

The embodiments described herein relate to vehicle driveline systems and, more particularly, to a high angle undercut free joint assembly for such driveline systems.

Constant velocity joints, such as undercut free (UF) joints, are used to transmit torque through an angle while maintaining a constant velocity ratio of unity between a driving and driven shaft members of the joint at all angles. Standard UF joints can typically achieve a 50° joint angle. To pursue a higher angle, while maintaining a driveshaft bar strength and keeping balls supported by outer race ball grooves, the outer race packaging size has to be increased, and this becomes the major hindrance for implementing this type of joint because the vehicle space is tightly packed. In addition, for the purpose of achieving a higher angle, some designs could reduce cage support and shorten outer race bowl length, both leading to a reduction of joint strength at the high angle, which is another important characteristic of a high angle joint. Moreover, shortening the outer race bowl length could make the ball groove length insufficient to support the balls at a high angle.

The above-described design considerations are addressed herein.

### SUMMARY

According to one aspect of the disclosure, an undercut free (UF) joint assembly for a vehicle driveline system is provided and includes an axle bar, an inner race, a stem, an outer race, and a cage. Also included are a plurality of balls retained within the cage, the axle bar able to articulate relative to the outer race, an opening chamfer of the outer race parallel to an outer surface of the axle bar oriented at the required joint angle.

According to another aspect of the disclosure, a driveshaft assembly is provided and includes a constant velocity joint. The constant velocity joint includes an axle bar. The joint also includes an outer race having an inner contact surface. The joint further includes an inner race having an outer contact surface. The joint yet further includes a cage. The joint also includes a plurality of balls retained within the cage and in contact with the inner contact surface of the outer race and outer contact surface of the inner race, the axle bar able to articulate relative to the outer race, an opening chamfer of the outer race parallel to an outer surface of the axle bar oriented at the required joint angle.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an undercut free (UF) joint assembly for a vehicle driveshaft assembly;

FIG. 2 is a sectional view taken along line B-B of FIG. 1;

FIG. 3 is a sectional view of an axle bar and an outer race of the UF joint assembly;

FIGS. 4-9 are schematic illustrations of a ball path of the UF joint assembly relative to other components of the UF joint assembly; and

FIG. 10 is a plot of a cage axis, an axle bar axis and an outer race axis.

### DETAILED DESCRIPTION

Referring now to the Figures, embodiments of a high angle undercut free (UF) joint assembly are illustrated. The UF joint assembly is utilized in a vehicle driveshaft assembly to transmit torque and rotation through an angle. The UF joint may be employed in numerous types of driveshaft assemblies that benefit from maintaining a constant velocity ratio of unity between a driving and driven shaft members of the joint over the full range of angular motion.

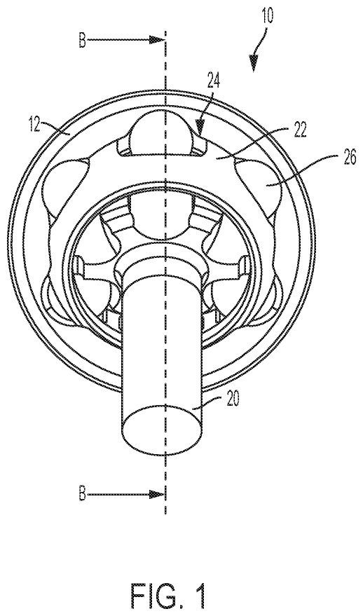

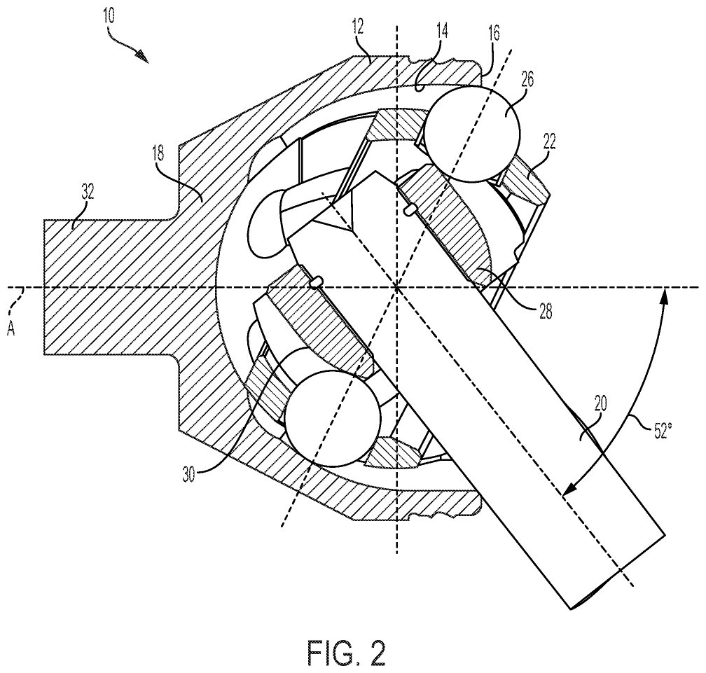

Referring to FIGS. 1 and 2, the UF joint assembly is referred to generally with numeral 10 in FIGS. 1 and 2. The UF joint assembly 10 includes an outer race 12 having an inner contact surface 14. The outer race 12 has at least one open end 16 at one axial end of the joint. In the embodiment shown, the axially opposite end of the outer race 12 has a closed end 18 from which an axle bar 20 extends.

The joint assembly 10 includes a cage 22 which is disposed at least partly within the outer race 12 and is formed to define a plurality of openings 24 spaced circumferentially from each other. Each opening 24 has a torque transmitting ball 26 disposed therein. Radially inward of the cage 22 is an inner race 28. The inner race 28 has an outer contact surface 30.

Each ball 26 engages the inner surface 14 of the outer race 12 and the outer surface 30 of the inner race 28 to enable the outer and inner races 12, 28 to articulate about each other. Any number of balls 26 can be provided with a minimum of three and as many as eight or more if desired, with both odd and even numbers of sets contemplated. The illustrated joint assembly 10 is of a six-ball configuration.

The outer race 12 is integrally formed with a stem 32. The axle bar 20 is rotatable over an angular range. Alignment of the longitudinal axes of the axle bar 20 and the stem 32 is one possible orientation of the joint assembly 10. This common axis is referenced with A. The axle bar 20 can articulate away from common axis A until contact between the axle bar 20 and the outer race 12 in one of two locations is made. These contact points function as one constraint for the angular range of motion. The embodiments described herein allow high angles to be achieved. For example, the axle bar 20 can articulate more than 50° away from common axis A.

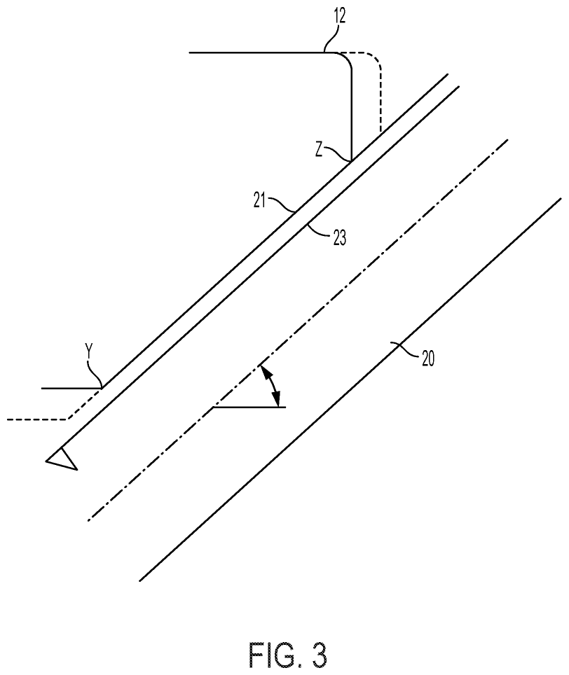

Referring now to FIG. 3, the axle bar 20 and a portion of the outer race 12 is illustrated in more detail. As described above, two potential contact locations are present. First, the axle bar 20 may contact an opening chamfer to opening diameter corner. This location is referenced with Y. Second, the axle bar 20 may contact the opening chamfer to front face corner. This location is referenced with Z. As shown, the line of the outer race 12 extending from location Y to location Z is substantially parallel to the bar undercut diameter surface line at the required joint angle with a small clearance between the axle bar 20 and the outer race 12 to account for manufacturing process tolerances, including dimensional stack-up.

The illustrated embodiment achieves three important advantages. First, the intended joint angle can always be achieved in a maximum material condition. Second, the outer race ball groove length can be maximized. Third, with the above-described parallelism, the joint angle will not be affected by attempts of decreasing outer race opening diameter or/and increasing outer race bowl length. In other words, while the joint angle is achieved, as shown in dashed lines, the opening diameter can be independently decreased for increasing cage support and outer race bowl length can be independently increased for improving outer race stiffness. Both measures can increase joint strength at high angle. The bowl length increase can also help increase much needed ball groove length for supporting balls at high angle.

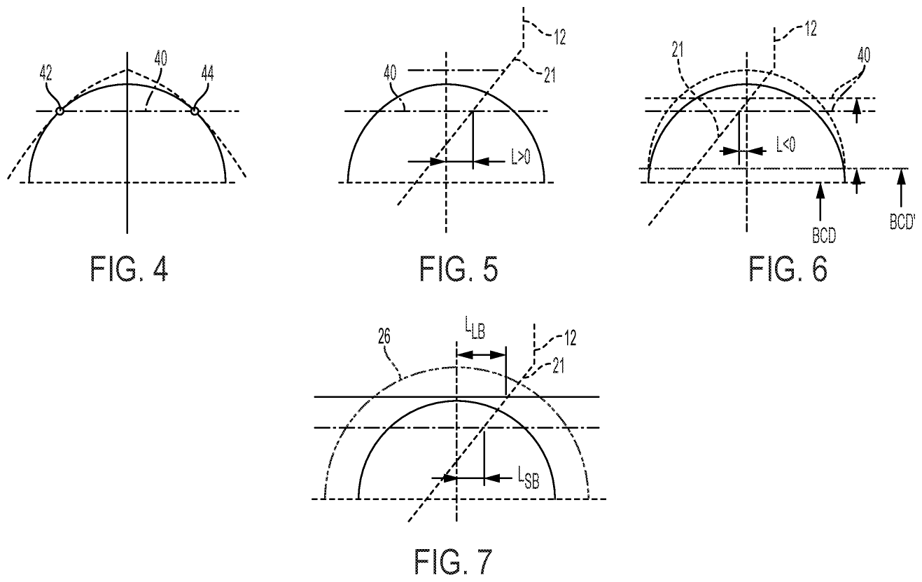

Referring now to FIGS. 4-6, paths of ball 26 are schematically illustrated relative to outer race. The ball paths are represented with numeral 40. To retain balls 26 by outer race ball grooves at the design angle, the axial location of outer race ball contact 42, 44 is further out relative to the ball center at this angle (L>0), as shown in FIG. 5. At higher angle, the ball center moves out more axially, and this can make the above requirement not met (L<0), as shown in FIG. 6. Given the outer race opening chamfer line YZ is fixed for the required joint angle, to resolve this deficiency, also shown in FIG. 6, the joint ball circle diameter (BCD) is increased to BCD′, that is, both ball center and ball contact trace move up radially to gain additional trace length or ball groove support length until it is able to support balls.

Referring now to FIG. 7, in a ball 26 that is larger than typical balls used in such applications, at comparable ball groove contact angles, the radial distance between ball contact trace and ball center is greater than the baseline (smaller) ball size used in regular 50° joint. Therefore, the larger size ball 26 brings more trace length (L_{LB}>L_{SB}). The ball circle diameter BCD is increased to achieve a higher design angle, but a larger size ball needs less increase of BCD. This lessened increase in BCD is enough to compensate for ball diameter increase. As a whole, the larger ball size introduces less packaging size increase. A larger size ball also improves joint durability and facilitates cage to outer race assembly.

Referring now to FIGS. 8 and 9, at a given ball diameter, while the design requirements in durability and kinematics are met, outer race ball grooves with a smaller contact angle can generate more trace length. As shown, with contact angles αD<αE, ball groove contact trace lengths L_{D}>L_{E}.

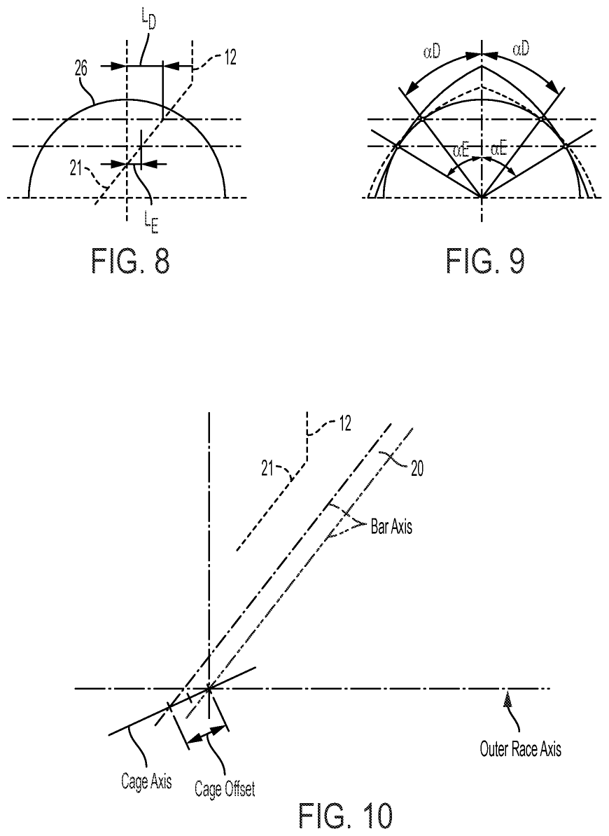

Referring now to FIG. 10, in conventional 50° UF joints, for the purpose of retaining ball groove depth in high angle area, a portion of outer and inner race offsets is assigned to the cage so that the outer race and inner race ball groove funnel angles can be reduced and ultimately the ball groove depth reduction can be more gradual longitudinally. As shown, the disadvantage with such an approach to joint angle capability is that it brings bar axis or bar undercut diameter surface closer to outer race and constrains outer race ball groove length. For the higher angle joint disclosed herein, adopting zero cage offsets can alleviate this concern, that is, an increased ball groove length and require less outer race size increase. On the other hand, the increased BCD makes it feasible to assign cage offsets back to races to maintain the comparable funnel angle. In addition, a cage without offsets can help joint run more smoothly and reduce manufacturing cost.

The embodiments described herein utilizes three design parameters which can extend outer race ball groove length and reduce the packaging size and an outer race opening chamfer design method that makes the joint angle independent of outer race opening diameter and outer race bowl length and ultimately improves joint strength at high angle. While existing designs may emphasize one at expense of others, the embodiments disclosed herein encompass considerations of joint angle capability, packaging size, and joint high angle strength altogether and offer a balanced solution to each of these aspects. The outer race opening chamfer design, larger size ball, smaller outer race ball groove contact angle, and zero-offset cage serve these objectives.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. An undercut free (UF) joint assembly for a vehicle driveline system comprising:
an axle bar;
an inner race;
a stem;
an outer race;
a cage; and
a plurality of balls retained within the cage, the axle bar able to articulate relative to the outer race, an opening chamfer of the outer race parallel to an outer surface of the axle bar oriented at the required joint angle.

2. The UF joint assembly of claim 1, wherein the axle bar that can articulate over 50° away from a common axis defined by the axle bar and the stem.

3. The UF joint assembly of claim 1, wherein the axle bar that can articulate to 52° or more away from the common axis.

4. The UF joint assembly of claim 1, wherein the outer surface of the axle bar oriented at the required joint angle and the outer race opening chamfer define a clearance therebetween.

5. The UF joint assembly of claim 1, wherein the outer race and the stem are integrally formed with each other.

6. The UF joint assembly of claim 1, wherein the ball is one of a plurality of balls retained within the cage.

7. The UF joint assembly of claim 1, wherein the joint angle of the axle bar is independent of an opening diameter of the outer race and a bowl length of the outer race.

8. A driveshaft assembly comprising:
a constant velocity joint comprising:
an axle bar;
an outer race having an inner contact surface;
an inner race having an outer contact surface;
a cage; and
a plurality of balls retained within the cage and in contact with the inner contact surface of the outer race and outer contact surface of the inner race, the axle bar able to articulate relative to the outer race, an opening chamfer of the outer race parallel to an outer surface of the axle bar oriented at the required joint angle.

9. The driveshaft assembly of claim 8, wherein the axle bar can articulate 50° away from a common axis defined by the axle bar and the stem.

10. The driveshaft assembly of claim 8, wherein the axle bar is able to articulate to 52° or more away from the common axis.

11. The driveshaft assembly of claim 8, wherein the outer surface of the axle bar oriented at the required joint angle and the outer race opening chamfer define a clearance therebetween.

12. The driveshaft assembly of claim 8, wherein the outer race and the stem are integrally formed with each other.

13. The driveshaft assembly of claim 8, wherein the ball is one a plurality of balls retained within the cage.

14. The driveshaft assembly of claim 8, wherein the joint angle of the axle bar is independent of an opening diameter of the outer race and a bowl length of the outer race.
